(19) United States
(12) Patent Application Publication
(10) Pub. No.: US 2026/0236682 A1
(43) Pub. Date: Aug. 13, 2026

(54) AUTOMATED TAXOMONY EXTENSION

(71) Applicant: Pinterest, Inc., San Francisco, CA (US)

(72) Inventors: Xiaochun Ma, East Meadow, NY (US); Abhijit Arvind Mahabal, Cupertino, CA (US)

(73) Assignee: Pinterest, Inc., San Francisco, CA (US)

(21) Appl. No.: 19/048,003

(22) Filed: Feb. 7, 2025

(51) Int. Cl. G06F 40/30; G06F 16/3329; G06F 16/36

(52) U.S. Cl. CPC G06F 40/30; G06F 16/3329; G06F 16/367

(57) ABSTRACT

Disclosed are systems and methods to enhance user engagement and personalization on digital platforms by employing Generative Artificial Intelligence (GenAI) techniques to suggest new nodes for a taxonomy. The process involves a GenAI technique to extract hypernyms from search query terms and a Retrieval-Augmented Generation (RAG) technique to expand a seed concept (i.e., node in a taxonomy), retrieve hyponyms (i.e., sub-categories) and come up with new node suggestions. This structured approach enables the automated extension of a taxonomy that enhances access to items maintained by an online service. The taxonomy nodes can be mapped to items, improving search accuracy and user interaction.

### BACKGROUND

Digital platforms have revolutionized user interaction with online content. These platforms provide access to an ever-growing amount of content. This continual growth of content creates a challenge in organizing the content and making the content accessible to users.

One technique to organize content is use of a taxonomy that provides classifications of the content. A taxonomy is based on relationships of hypernyms (e.g., class or parent) that are associated with hyponyms (e.g., sub-class or child). In a taxonomy, nodes of hypernyms may be associated with certain nodes of hyponyms. The taxonomy may expand out to a vast number of nodes and levels representing relationships between hypernyms and hyponyms. Content may then be organized under these nodes to classify and organize the content. Such classification may be used to provide more relevant search results, recommendations, or other information to users seeking content.

Currently, taxonomies are created manually or with substantial human involvement in the selection of nodes. Use of humans in creating and maintaining taxonomies is labor intensive and costly. Manual creation can also be slow to expand taxonomies for new types of content that are rapidly expanding and evolving over time.

### BRIEF DESCRIPTION OF THE DRAWINGS

FIG. 1 is a schematic diagram of an illustrative environment to provide automated taxonomy extension in response to user interaction with a computing resource, according to exemplary implementations of the present disclosure.

FIG. 2 is a block diagram illustrating an exemplary computing configuration to provide automated taxonomy extension, according to exemplary implementations of the present disclosure.

FIG. 3 is a schematic diagram showing example user search queries and results organized using an underlying taxonomy that is expandable based on user search history, according to exemplary implementations of the present disclosure.

FIG. 4 is a flow diagram of an exemplary process to expand a taxonomy based on user interaction and provide results to users using the expanded taxonomy, according to exemplary implementations of the present disclosure.

FIG. 5 is a flow diagram of an exemplary process to analyze user search queries to determine hypernym-hyponym relationships to expand a taxonomy, according to exemplary implementations of the present disclosure.

FIG. 6 is a flow diagram of an exemplary process to expand a node of a taxonomy using a seed concept, according to exemplary implementations of the present disclosure.

FIG. 7 is a flow diagram of an exemplary process to apply Retrieval-Augmented Generation (RAG) to consolidate candidate nodes for a taxonomy, according to exemplary implementations of the present disclosure.

FIG. 8 is a flow diagram of an exemplary process to create training data to associate content with new nodes of a taxonomy, according to exemplary implementations of the present disclosure.

FIG. 9 is a schematic diagram of an illustrative taxonomy that is automatically expanded to add new nodes based on user interaction with content, according to exemplary implementations of the present disclosure.

FIG. 10 is a block diagram illustrating an exemplary computing resource, according to exemplary implementations of the present disclosure.

### DETAILED DESCRIPTION

As is set forth in greater detail below, implementations of the present disclosure are directed toward automatic expansion of taxonomies used to efficiently organize content for user retrieval. Every day, the amount of content that is available for user consumption expands which can create an overwhelming amount of information. This expansion of content requires organization of the new content to allow users to efficiently discover and retrieve desirable content.

Taxonomies are often used to organize content through a classification scheme. While taxonomies are conventionally created using significant human input, disclosed techniques describe automating creation and expansion of taxonomies. For example, large language models (LLM) and Generative Artificial Intelligence (GenAI) may be used to determine nodes of a taxonomy based on content that is available for user consumption, user inputs, or other data.

In some embodiments, users may access a service to find content using user search queries. The user search queries include one or more terms that may later be used with other search queries to discover and add nodes to a taxonomy to enable providing better search results to subsequent users. A service may associate search terms with hypernyms, such as by using an LLM, to create hypernym-hyponym pairings. These pairings may then be used to create a mapping of new nodes to add to a taxonomy.

In some embodiments, hypernym-hyponym pairings may be used to create a set of candidate hyponyms for a given hypernym. The given hypernym may be selected as a seed concept from an existing taxonomy or may be selected in other ways, such as based on popularity of use of certain search terms and so forth. The set of candidate hyponyms may include duplication of terms, irrelevant terms, and other terms capable of consolidation. For example, a hypernym of “age” may include candidate hyponyms of “teen,” “teenager,” “sixteen,” “pre-adult,” etc. Some of these hyponyms may be consolidated to “teenager” or another term that encompasses multiple variations of this concept. In some embodiments, a computing resource may use Retrieval-Augmented Generation (RAG) to consolidate the set of hyponyms to a candidate set of new nodes that may be used to expand a taxonomy. The RAG may be implemented using iterations that select candidate nodes based on a number of occurrences of the candidate nodes in processed results, possibly in relation to a threshold value.

At least some of the new nodes may be added to a taxonomy. The service may associate content to the new nodes to enable user discovery and content retrieval using the taxonomy. For example, items of a catalog may be organized by the taxonomy. As users submit search queries to a service, the service may use the taxonomy to provide relevant results to the users in response to the search queries. In some embodiments, the taxonomy or a portion of the taxonomy may be provided to users to discover content.

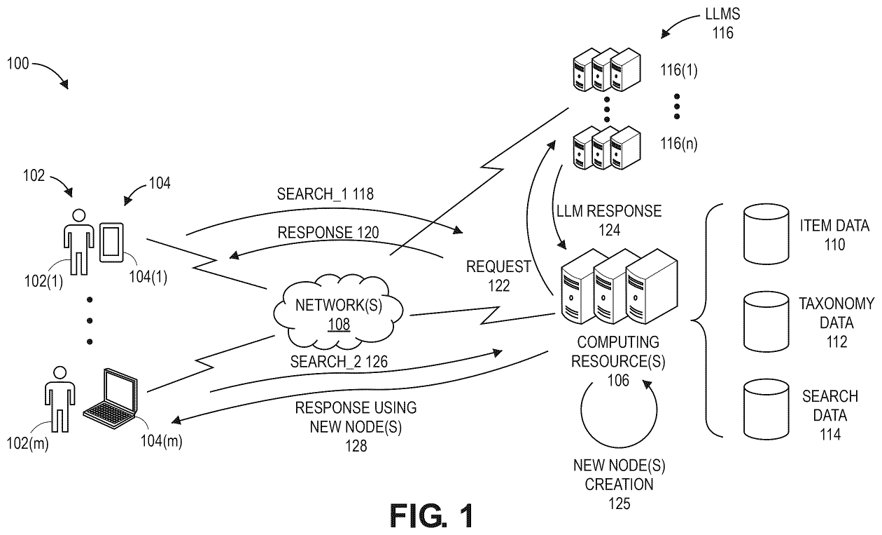

The above concepts are described in further detail below with reference to FIGS. 1-10. While concepts of the disclosure are discussed using different Figures, embodiments of the disclosure may include aspects from a combination of the Figures.

FIG. 1 is a schematic diagram of an illustrative environment 100 to provide automated taxonomy extension in response to user interaction with a computing resource, according to exemplary implementations of the present disclosure. The environment 100 may include users 102, each associated with one of the user devices 104. The user devices 104 may include any type of computing device, such as a smartphone, tablet, laptop computer, desktop computer, wearable, etc. The user devices 104 may include one or more processors and one or more memory which may store one or more client applications, such as a web browser, social networking application, shopping application, etc.

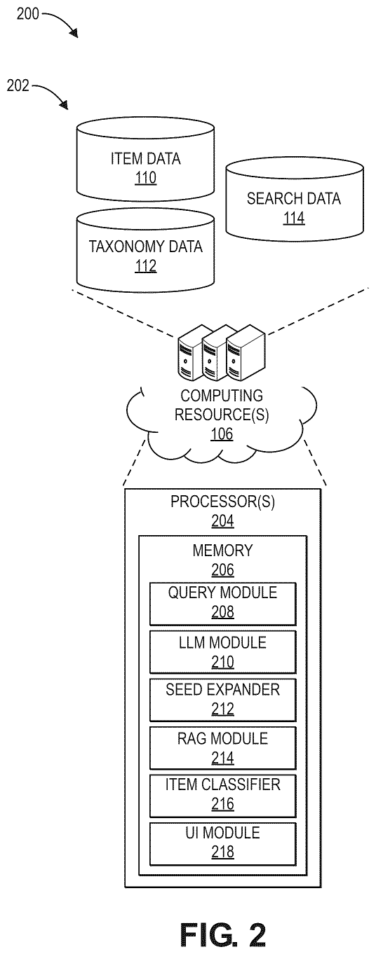

The users 102 may interact with computing resources 106 using the user devices 104. According to exemplary implementations of the present disclosure, computing resources 106 may be representative of computing resources that may form a portion of a larger networked computing platform (e.g., a cloud computing platform, and the like), which may be accessed by the user devices 104. The computing resources 106 may provide various services and/or resources and do not require end-user knowledge of the physical premises and configuration of the system that delivers the services. For example, the computing resources 106 may include “on-demand computing platforms,” “software as a service (SaaS),” “infrastructure as a service (IaaS),” “platform as a service (PaaS),” “platform computing,” “network-accessible platforms,” “data centers,” “virtual computing platforms,” and so forth. Example components of the computing resources 106 are described with reference to FIG. 2.

The computing resources 106 may host a service or multiple services and may be configured to execute and/or provide a social media platform, a social networking service, a recommendation service, a search service, an e-commerce platform, and/or any other form of interactive computing. The content available through the computing resources 106 may expand over time. For example, the content made available to the users 102 may expand or otherwise increase based on creation of new content by third party providers and/or other users. The content may expand for other reasons, such as creation of content by artificial intelligence (AI) systems and/or other computing sources. The computing resources 106 may include access to various data stores that store information such as item data 110, taxonomy data 112, and search data 114.

One or more networks 108 may facilitate an exchange of data between the user devices 104 and the computing resources 106. The network(s) 108 may be wired and/or wireless networks that transmit data or otherwise interact between the user devices 104 and the computing resources 106, possibly through other intermediary devices. For example, the network(s) 108 may be a personal area network, local area network, wide area network, over-the-air broadcast network (e.g., for radio or television), cable network, satellite network, cellular telephone network, or combination thereof. As a further example, the network 108 may be a publicly accessible network of linked networks, possibly operated by various distinct parties, such as the Internet. In some implementations, the network 108 may be a private or semi-private network, such as a corporate or university intranet. The network 108 may include one or more wireless networks, such as a Global System for Mobile Communications (GSM) network, a Code Division Multiple Access (CDMA) network, a Long Term Evolution (LTE) network, or any other type of wireless network. The network 108 can use protocols and components for communicating via the Internet or any of the other aforementioned types of networks. For example, the protocols used by the network 108 may include Hypertext Transfer Protocol (HTTP), HTTP Secure (HTTPS), Remote Procedure Call (RPC), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

The computing resources 106 may access one or more large language models (LLMs) 116, which may include one or more GenAI models. The LLMs may provide responses to the computing resources in response to prompts provided by the computing resources 106. For example, the computing resources 106 may send a request to a first LLM 116(1) to provide a mapping of hypernyms to search terms included in the search data 114. In response, the first LLM 116(1) may generate hypernym-hyponym pairings in response to the request and send the pairings to the computing resources 106 for further processing. As another example, the computing resources 106 may send a set of hyponyms to a second LLM 116(n) (or possibly to the first LLM) to consolidate the set of hyponyms to create candidate nodes to add to a taxonomy included in the taxonomy data 112. The second LLM may implement RAG to consolidate the set of hyponyms based on instructions that include a seed concept, an existing taxonomy, and the set of hyponyms.

The following example actions may be performed using the environment 100. A first user 102(1) may submit a search query 118, via a first user device 104(1), to discover or otherwise retrieve content provided by the computing resources 106. For example, the first user 102(1) may create a search query of “preppy fashion for top colleges” and may submit the search query 118 to the computing resources 106 that may provide content in response to the search query 118. In turn, the computing resources 106 may provide a response 120 based on the search query 118. The response 120 may be content that is relevant to the search query 118 and possibly organized using a taxonomy. For example, the computing resources 106 may process the search query 118 using the taxonomy data 112 and the item data 110 to generate the response 120 that may include search results, content suggestions, content for consumption by the first user 102(1), and/or other data. In addition, many other users may submit similar search queries and obtain responses in a similar manner. The search query 118 and other search queries may be stored in the search data 114, which may include search terms, search queries, and/or user interactions in response to search queries. The user interactions may include content accessed by the users following a response to a search query.

The computing resources 106 may send a request 122 to one or more of the LLMs 116. The request 122 may include at least some of the search data 114 to create hypernym-hyponym pairings to expand a taxonomy used to organize content. The request may include instructions to the LLM, such as the first LLM 116(1). In response, the LLM's may provide an LLM response 124. The LLM response 124 may include the hypernym-hyponym pairings and/or other data in response to the request 122. The computing resources may process the LLM response 124 to perform new node(s) creation 125 to create new nodes for the taxonomy, organize content using the new nodes, and/or perform other operations using the LLM response 124.

At a later time, a second user 102(m) may submit a search query 126, via a second user device 104(m), to the computing resources 106. The search query 126 may be a request for content. For example, the second user 102(m) may create a search query of “smart fashion wear for school” and may submit the search query 126 to the computing resources 106 that may provide content in response to the search query 126. The computing resources 106 may process the search query 126 to provide search results using the taxonomy that includes one or more new nodes based on the LLM response 124. The computing resources 106 may then send a response using the new node(s) 128, created via the new node(s) creation 125, to fulfill the search query 126. The response using the new node(s) 128 may include an organization of the items (e.g., content items) that was not previously available when the first user 102(1) submitted the search query 118 at an earlier time.

FIG. 2 is a block diagram illustrating an exemplary computing configuration 200 to provide automated taxonomy extension, according to exemplary implementations of the present disclosure. The computing configuration 200 may include the computing resources 106. As described with reference to FIG. 1, the computing resources 106 may include access to one or more data stores 202 which may include the item data 110, the taxonomy data 112, and/or the search data 114.

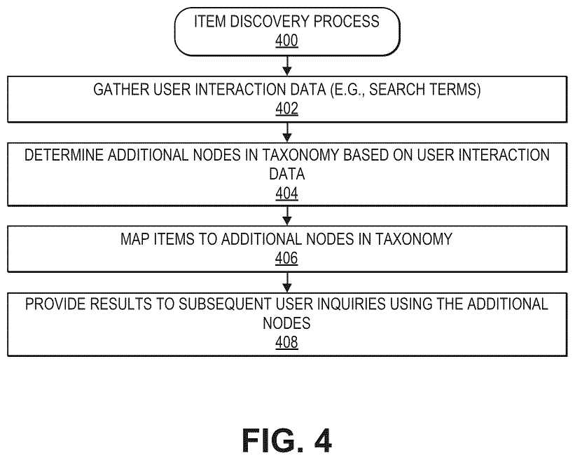

The computing resources 106 may include one or more processors 204 and one or more memory 206 storing various modules, components, and/or software to perform at least some of the operations of the processes described with reference to FIGS. 4-8 below.

In accordance with some embodiments, the memory 206 may store a query module 208. The query module 208 may receive user search queries and in response, return search results, content items, nodes of a taxonomy, and/or other results to a user device associated with the user. The query module 208 may store search queries and/or terms used in search queries in the search data 114. In various embodiments, the query module 208 may associate at least some user interaction data with certain search terms. The user interaction data may be information about how the user interacted with search results. The user interaction data may be used as training data to associate content items with new nodes created for the taxonomy based at least in part on the search terms. Using the query module 208, search queries may be collected and possibly pre-processed to ensure relevancy and appropriateness for input of the taxonomy. For example, irrelevant or absurd search queries may be flagged by the query module 208 and excluded from the search data 114.

The memory 206 may store an LLM module 210 that may send a request to one or more LLM and receive results for the LLM. For example, the LLM module 210 may send at least some search terms included in the search data 114 to an LLM with instructions to create hypernym-hyponym pairings for each of the search terms or for a subset of the search terms. In various embodiments, the LLM module 210 may send a request to the same LLM or to another LLM to expand a set of hypernyms, hyponyms, or both based at least in part on the hypernym-hyponym pairings. This request may leverage the abilities of the LLM to add additional concepts to the hypernym-hyponym pairings to create additional concepts for possible inclusion in the taxonomy. As another example, a GenAI model may identify potential hypernyms for each search query term. This may involve assessing, by one or more LLM, semantic relationships and ensuring the hypernyms accurately represent general categories applicable to multiple instances.

A seed expander 212 may select a node from an existing taxonomy as a seed concept to expand using the hypernym-hyponym pairings. In some embodiments, the seed expander 212 may select the seed concept from the hypernym-hyponym pairings or from other information, such as based on popularity of search terms, recency of search terms, user interaction data, or other factors. The seed expander 212 may determine a hypernym for the seed concept using the hypernym-hyponym pairings. The seed expander 212 may then group hypernyms similar to the seed concept, possibly using a request to one of the LLMs. The seed expander 212 may then select candidate hyponyms from the group of similar hyponyms to the seed concept and including the seed concept. In one or more embodiments, the seed expander 212 may expand seed concepts into similar meaning concepts using a variety of techniques. A first technique includes using embedding and similarity measurements. Concepts may be represented as vectors using cosine similarity to find related concepts. A second technique includes clustering like methods. Similar concepts may be grouped using algorithms such as k-means or hierarchical clustering. A third technique includes knowledge graph utilization. Existing relationships in a knowledge graph may help identify and expand related concepts. In some embodiments, the seed expander 212 may also identify hyponyms that fall under the broader category defined by the hypernyms, which may be helpful to increase accuracy in the taxonomy.

A RAG module 214 may consolidate the candidate hyponyms to a reduced set of hyponyms to create candidates for new nodes of the taxonomy. The RAG module 214 may receive a prompt that includes the seed concept, the candidate hyponyms, and possibly an existing taxonomy or example taxonomy. In some embodiments, the RAG module 214 may also receive as input at least some of the search terms from the search data 114 and/or at least some content information from the item data 110. The RAG module 214 may send the input data to an LLM to consolidate the candidate hyponyms for the seed concept. As an example, the RAG module 214 may begin with twenty candidate hyponyms, where some of the candidates are closely related to other candidates, such as synonyms of other hyponyms. The RAG module 214 may receive a consolidated set of hyponyms after processing by the LLM of fewer than twenty (e.g., ten, eight, etc.) hyponyms for the seed concept, which may be candidates for new nodes of the taxonomy. In some embodiments, the RAG module 214 may implement an iterative approach to processing the hyponyms, which may return results or ranked results for each iteration of the RAG being performed. Results or occurrences of each hyponym may be tallied or otherwise tracked and compared to a threshold value. When occurrences reach or pass the threshold, the associated hyponym may be selected as a new node. By performing the iterative approach, results created by hallucinations by an LLM may be removed since the hallucinations are unlikely to have enough occurrences to pass the threshold. The RAG module 214 may send a predetermined number of requests (iterations) to the LLM for processing and tallying as described. In various embodiments, the RAG module 214 may prevent duplication of nodes in the taxonomy or redundancy of similar new nodes created for a seed concept.

An item classifier 216 may be used to associate items included in the item data 110 to the new nodes for the taxonomy. The item classifier 216 may integrate new nodes or suggested nodes into a new or existing taxonomy framework. Feedback mechanisms and validation checks may be added to ensure each new node enhances user ability to navigate and access content efficiently.

In some embodiments, the item classifier 216 may be trained based at least in part from user interaction data captured by the query module 208. The user interaction data may be associated with a search term, which is also associated with a new node. This user interaction data (e.g., items selected by user in response to a search query, etc.) may inform training of the item classifier 216 to better associate content with the new nodes of the taxonomy. The association of content to the taxonomy then allows content to be organized for improved presentation to users to aid discovery and retrieval of content by users.

A user interface (UI) module 218 may provide the taxonomy with the new nodes to a user interface for exploration or other interaction by a user. In some embodiments, the UI module 218 may provide search results from the query module 208 organized using new nodes of the taxonomy based on the output of the RAG module 214 and item classifier 216. As an example, a taxonomy of fashion may be enhanced using the components and techniques described above. Given a current set of styles, the components are tasked with incorporating new fashion trends into the taxonomy given user search terms as an input. The RAG technique accesses a representation of the taxonomy and evaluates new style candidates under a specified “query node.” Styles appropriate as direct descendants of the “query node” are considered to ensure that the taxonomy remains precise and relevant to the category of fashion, in this example. Further details about the various modules, components, and other software stored in the memory are described below with reference to various processes in FIGS. 4-8.

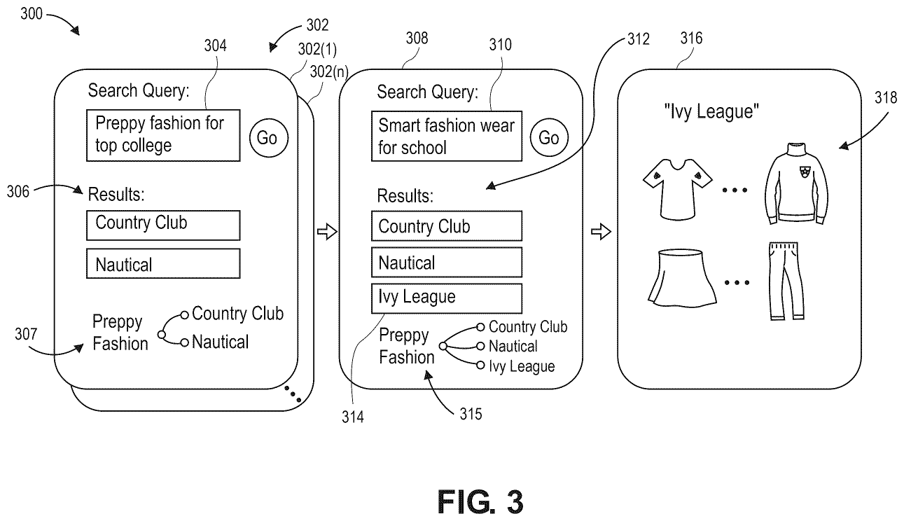

FIG. 3 is a schematic diagram showing example UIs 300 including user search queries and results organized using an underlying taxonomy that is expandable based on user search history, according to exemplary implementations of the present disclosure. The UI module 218 may provide the example UIs described with reference to FIG. 3.

First UIs 302 may capture user search queries 304 and provide results 306 in response to the user search queries. The results 306 may be associated with nodes of a taxonomy used to categorize or otherwise organize content. For example, the user search for a first UI 302(1) may include text of “preppy fashion for top college,” where the user is searching for fashion wear in a catalog of items. The results 306 to this query may include a first node of country club and a second node of nautical, which may be hyponyms of a node “preppy fashion” in a taxonomy. Each node may include items organized under the node, which may be presented to the user upon selection of a corresponding node. In some embodiments, the fist UI 302(1) may include a taxonomy snippet 307 showing a hypernym and associated hyponyms, which may enable user interaction to discover content items.

Additional first UIs 302 may also be presented to other users for similar purposes and capture user search queries of one or more terms, such as an additional UI 302(n). The user search queries may be stored in the search data 114 shown in FIG. 2. In some embodiments, user interaction with the results 306 may also be captured in the search data 114 or in other data stores. This user interaction data may be used to train an item classifier, such as the item classifier 216 of FIG. 2, to associate items with new nodes in the taxonomy.

From time to time, new nodes may be automatically generated for the taxonomy and may change an output that users receive to help the users discover content or more efficiently retrieve content. A second UI 308 may be created after at least one new node is added to the taxonomy. A user search query 310 may include text of “smart fashion wear for school,” where a different user is again searching for fashion wear in a catalog of items. The results 312 to this query may include a first node of country club, a second node of nautical, and a new node 314 of “ivy league” that was created based on the prior search queries captured from the first UIs 302. For example, terms such as “top college” and “preppy” may have been used with other search terms captured by the first UIs to create hyponyms associated with a hypernym of “preppy fashion.” Through hypernym expansion, seed expansion, and RAG, the new node of “ivy league” may be added to the taxonomy. The item classifier 216 of FIG. 2 may associate items with the new node of “ivy league,” which may be made accessible via the new node 314 presented via the second UI 308. In some embodiments, the second UI 308 may include a second taxonomy snippet 315 showing a hypernym and associated hyponyms, which may enable user interaction to discover content items. The associated hyponyms may include a new node, such as “ivy league.”

A third UI 316 may be presented to a user in response to selection of a command associated with “ivy league,” such as the new node 314 or an associated portion of the second taxonomy snippet 315. The third UI 316 may provide content items 318 classified under the new node.

FIG. 4 is a flow diagram of an exemplary process 400 to expand a taxonomy based on user interaction and provide results to users using the expanded taxonomy, according to exemplary implementations of the present disclosure. The example process of FIG. 4 and each of the other processes and sub-processes discussed herein may be implemented in hardware, software, or a combination thereof. In the context of software, the described operations represent computer-executable instructions stored on one or more computer-readable media that, when executed by one or more processors, perform the recited operations. Generally, computer-executable instructions include routines, programs, objects, components, data structures, and the like that perform particular functions or implement particular abstract data types.

The computer-readable media may include non-transitory computer-readable storage media, which may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of storage media suitable for storing electronic instructions. In addition, in some implementations, the computer-readable media may include a transitory computer-readable signal (in compressed or uncompressed form). Examples of computer-readable signals, whether modulated using a carrier or not, include, but are not limited to, signals that a computer system hosting or running a computer program can be configured to access, including signals downloaded through the Internet or other networks. Finally, the order in which the operations are described is not intended to be construed as a limitation and any number of the described operations can be combined in any order and/or in parallel to implement the routine. Likewise, one or more of the operations may be considered optional. Various operations from different processes may be combined in accordance with various embodiments.

The process 400 may begin with the query module 208 gathering user interaction data, as in 402. The user interaction data may include user search queries submitted to the query module 208. For example, users may access the computing resources 106 in search of specific content. The content may change over time with the addition of new content. Content may be consumable by users and include physical items, digital items, services, or a combination thereof. In some embodiments, the query module may gather user interaction with search results provided by the computer resources 106. This information may be used to train the item classifier 216, among other possible uses.

The seed expander, in conjunction with the LLM module 210 and/or the RAG module 214, may determine additional nodes to be added in the taxonomy based on the user interaction data, as in 404. For example, the LLM module 210 may process at least some of the search terms to create hypernym-hyponym pairings. The seed expander 212 may use the hypernym-hyponym pairings to create candidate nodes. The RAG module 214 may consolidate the candidate nodes to identify new nodes to add to the taxonomy.

The item classifier 216 may map items to the new nodes in the taxonomy, as in 406. As an example, a new node of “ivy league” may be added to a hypernym of “preppy fashion” in a fashion taxonomy. Next, the item classifier 216 may associate certain fashion items with the new node, such as certain sweaters, scarves, etc. The item classifier 216 may use training data stored with the search data 114 to perform the classification. For example, the new node of “ivy league” may be created in response to and associated with a search term of “ivy.” The search term of “ivy” may also be associated with downstream user activity, such as selection of certain fashion items such as a particular sweater. This relationship may be used to train the item classifier 216 to map the items to the new node of “ivy league.”

The UI module 218 may provide results to subsequent user inquiries using the new nodes, as in 408. Continuing with the example above, the fashion items may be returned in response to a subsequent user search query that uses the taxonomy to return results to the user. In some embodiments, the UI module 218 may allow the user to browse for items by exploration or interaction with the taxonomy. For example, portions of the taxonomy may be provided to the user in response to a search result, which may be selected to provide the user with relevant results. The UI module 218 may therefore enable the user to discover and retrieve relevant items using the new nodes of the taxonomy.

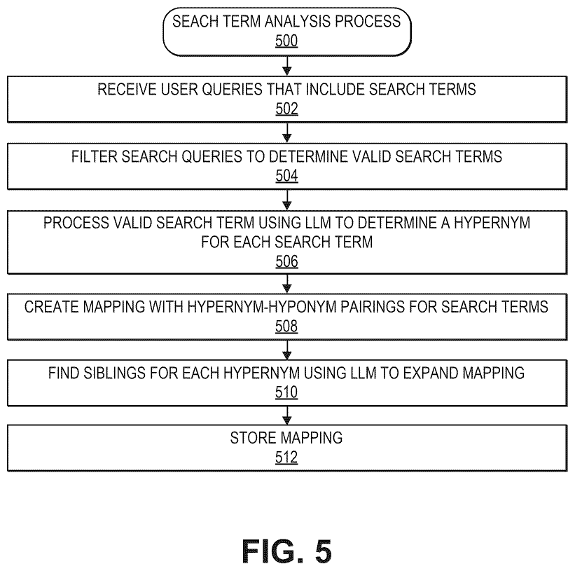

FIG. 5 is a flow diagram of an exemplary process 500 to analyze user search queries to determine hypernym-hyponym relationships to expand a taxonomy, according to exemplary implementations of the present disclosure. The process 500 may begin by the query module 208 receiving user queries that include one or more search terms, as in 502. The query module 208 may capture the search terms in a text input field, via audio, and/or by submission of imagery (e.g., image or video). Audio inputs may be converted to text using speech-to-text algorithms. Imagery may be converted to text using image analysis tools, such as GenAI tools or other image analysis tools that can extract features from an image for association with text. For example, a user may be searching for music and may submit a sample of music as a search input or may submit an image such as album artwork.

The query module 208 may filter search queries to determine valid search terms, as in 504. For example, the query module 208 may attempt to fulfill all search queries but may flag some search queries as poor candidates for creation of new nodes such as when the search query includes abusive language, gibberish, or other incoherent information. This data may be disregarded or possibly not stored in the search data 114 to avoid using this data to create new nodes. For example, the query module 208 may restrict data stored in the search data 114 as valid search terms. When images or audio are used to search, the query module 208 may store text translations of these searches in the search data 114. In some embodiments, a frequency of search terms may be used to select search terms for further processing to create new nodes for a taxonomy. The query module 208 may prepare search query terms using search query frequency to determine whether to break down the query into n-grams and which n-grams to keep.

The LLM module 210 may process the valid search terms to determine a hypernym for each search term or for some search terms, as in 506. In some embodiments, a search term may be defined as multiple words, such as the term “ivy league” when certain words are commonly used together. Search terms may also be processed as individual words. Some search terms may be excluded from processing, such as “a,” “the,” and other words that are not descriptive but are frequently included in search queries.

The LLM module 210 may create a mapping with hypernym-hyponym pairings, as in 508. The LLM module 210 may create hypernym-hyponym pairings that include a hypernym for each search term or terms. These pairings may be used to form the mapping. The mapping may be stored with the search data 114 or may be stored by an LLM that is remote from the computing resources 106.

The LLM module 210 may determine siblings for each hypernym using the LLM to expand the mapping, as in 510. For example, the LLM module 210 may identify a hypernym-hyponym pairing of “age: teenager” where “age” is the hypernym and “teenager” is the hyponym. The LLM module 210 may send instructions to an LLM to expand a hypernym of “age.” The LLM may then create one or more additional pairings with “age,” such as “age: adult” or “age: child.”

The LLM module 210 may store the mapping, as in 512. The LLM module 210 may store the mapping in the search data 114 or with a remote service, such as with the LLM for later recall during further processing described with reference to FIG. 5.

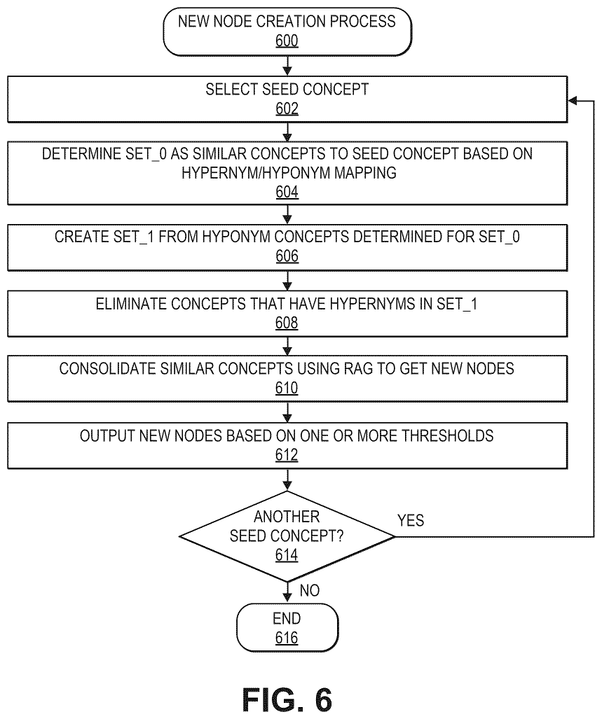

FIG. 6 is a flow diagram of an exemplary process 600 to expand a node of a taxonomy using a seed concept, according to exemplary implementations of the present disclosure. The process 600 may begin with the seed expander 212 selecting a seed concept, as in 602. The seed concept may be a node of an existing taxonomy. In some embodiments, the seed concept may be selected in other ways, such as based on popularity of search terms, items in a catalog, user requests, and so forth.

The seed expander 212 may determine a set_0 (“first set”) as similar concepts to the seed concept selected at the operation 602, as in 604. The similar concepts may be selected based on the mapping that includes the hypernym-hyponym pairing. For example, the seed concept may be “shirt” and the similar concepts may be selected as “blouse,” “t-shirt,” “athletic shirt,” etc. In some embodiments, the seed expander 212 may use prompting techniques to provide multiple hypernyms for terms with more than one meaning. The prompting techniques may include a short description of content to add context to a term. The prompting techniques may rank hypernyms for a search query term based on logic, such as logic deployed by an LLM. The seed expander 212 may use embedding vectors to represent concepts as vectors in a semantic space. The seed expander 212 may calculate a similarity between the seed concept and hypernyms using measures like cosine similarity. The seed expander 212 may cluster related concepts based on their vector representations to identify similar meaning concepts. The seed expander 212 may leverage a knowledge graph to explore and retrieve related entities and concepts based on existing relationships known by an LLM.

The seed expander 212 may create a set_1 (“second set”) from hyponym concepts determined for the first set, set_0, as in 606. For example, the hypernym “blouse” may include hyponyms of “camisole,” cap sleeve,” etc. The hypernym “athletic shirt” may include hyponyms of “tank top” and “sleeveless.” The hypernym of “t-shirt” may include hyponyms of “shirt,” “basic shirt,” and “undershirt.” The seed expander 212 may add the hyponyms to the second set, set_1. Thus, the second set may include the following hyponyms for the seed concept of “shirt”: “camisole,” “cap sleeve,” “tank top,” “sleeveless,” “shirt,” “basic shirt,” and “undershirt.”

The seed expander 212 may eliminate or remove concepts that have hypernyms in the set_1, as in 608. From the example hyponyms listed above, the hyponym of “shirt” is also a hypernym (and the seed concept). Therefore, the seed expander would remove this hyponym from the candidate hyponyms. The result would then include the following hyponyms for the seed concept of “shirt”: “camisole,” “cap sleeve,” “tank top,” “sleeveless,” “basic shirt,” and “undershirt.”

The RAG module 214 may consolidate similar concepts using RAG to get new candidate nodes, as in 610. For example, the list of hyponyms from the operation 608 includes seven hyponyms. The RAG module 214 may send instructions to an LLM to perform RAG and may include the candidate hyponyms from the operation 608, the seed concept (“shirt”), and possibly an existing taxonomy. In some embodiments, the RAG module 214 may send other information to the LLM to perform the RAG, such as search terms, items in a catalog, item descriptions, and/or other contextual information. The LLM may consolidate the hyponyms such as by removing some hyponyms and merging similar hyponyms. Following the RAG of the candidate hyponyms, the resulting new nodes for the seed concept of “shirt” may be identified as “camisole,” “cap sleeve,” “sleeveless,” and “undershirt.” The hyponyms of “tank top” and “basic shirt” may be removed or otherwise merged with other hyponyms (e.g., “tank top” merged with “sleeveless”).

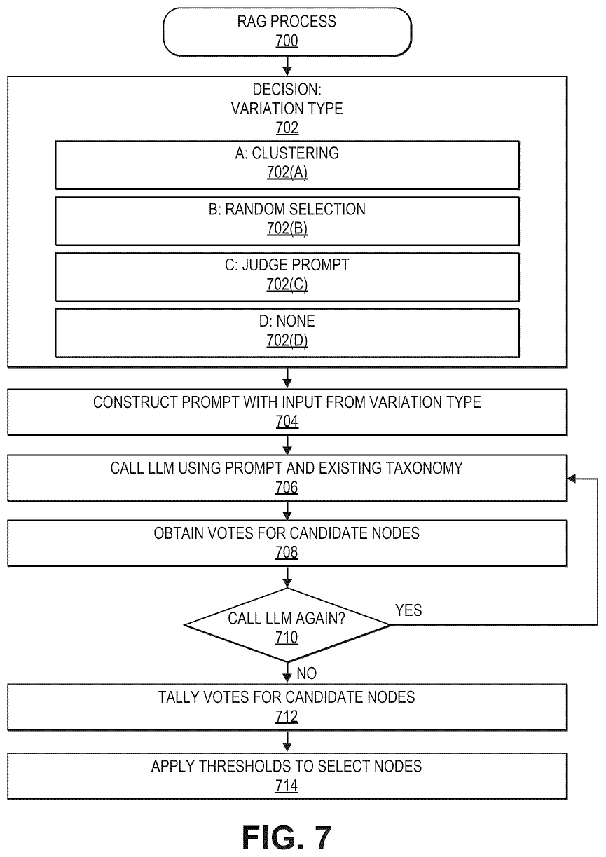

The RAG module 214 may output the new nodes based on one or more thresholds, as in 612. For example, the RAG may be performed using iterations and results may be tallied to determine an occurrence of a particular result. For example, a first pass of the RAG may produce the following candidate new nodes.
camisole
cap sleeve
sleeveless
undershirt
   After a predetermined number of iterations of the RAG, the tallied results may include the following, where (x) indicates the number of occurrences.
camisole (3)
tunic (1)
jumper (1)
cap sleeve (4)
boxers (1)
sleeveless (8)
undershirt (3)
   The RAG module 214 may apply a minimum threshold number of occurrences for the candidate new nodes, such as a threshold of two. Thus, candidate nodes with less than two occurrences may be disregarded or pruned from the results. The threshold may remove hallucinations generated by LLMs during processing. For example, the result of “boxers” may be a hallucination because boxers are not a subset of “shirt.” By tallying votes, hallucinations are likely to be eliminated by an iterative RAG process. The following list may be selected and output as new nodes after implementation of the threshold.
camisole (3)
cap sleeve (4)
sleeveless (8)
undershirt (3)
   As discussed in further detail with reference to FIG. 7, additional techniques may be used to group, cluster, or consolidate hyponyms to create the new nodes.

The RAG module 214 may determine whether to process another seed concept, as in 614. When the RAG module 214 determines to process another seed concept, following the “yes” route from the decision operation 614, the process 600 may advance to the operation 602 and continue processing. For example, the RAG module 214 may process some or all seed concepts in a taxonomy or may process other candidates for seed concepts until a pool of candidate seed concepts is exhausted. The RAG module 214 may repeat the entire process from time to time to automatically refresh the nodes in the taxonomy as new content is created, such as on a daily, weekly, random, or other iteration.

When the RAG module 214 determines not to process another seed concept, following the “no” route from the decision operation 614, the process 600 may advance to an operation 616. The RAG module 214 may terminate processing, as in 616.

FIG. 7 is a flow diagram of an exemplary process 700 to apply Retrieval-Augmented Generation (RAG) to consolidate candidate nodes for a taxonomy, according to exemplary implementations of the present disclosure. The process 700 may begin with the RAG module 214 determining a variation type, as in 702. In some instances, the set of candidate hyponyms may be relatively large or greater than a threshold size. The RAG module 214 may perform one or more additional operations to determine the new nodes from the candidate hyponyms. One variation is to use clustering to reduce the number of candidate hyponyms, as in 702(A). Clustering may merge similar hyponyms, such as hyponyms that are variations of a same word or closely related words. For example, clustering may merge the hyponyms of “T-shirt,” “tshirt” and “t-shirts,” In this example, the result may include three occurrences of the same term, such as “T-shirt” or the result may be a single occurrence of the term.

The RAG module 214 may use random selection to select hyponyms for consolidation by the LLM, as in 702(B). Random selection may remove some hyponyms for a first iteration, remove different hyponyms in a second iteration, and so forth. Use of the random selection may result in different output and occurrences of candidate nodes, which can then be counted or tallied over the iterations for selection of the candidate nodes.

The RAG module 214 may use a judge prompt for hyponym consolidation, as in 702(C). A judge prompt may enable a judge to modify the hyponyms for consideration by the LLM. The judge may be a human or may be an automated process that removes hyponyms prior to processing by the LLM. For example, certain words may be removed if present in a blacklist.

In some embodiments, the RAG module 214 may determine not to use any variation, as in 702(D). For example, when the candidate set of hyponyms is less than a threshold size, the RAG module 214 may determine not to use any variation from the options 702(A)-(C).

The RAG module 214 may construct a prompt for an LLM to process the RAG using input from the selection at the operation 702, as in 704. The prompt may include the seed concept, any candidate hyponyms for processing for an iteration, and a taxonomy. The taxonomy may provide the LLM an illustrative structure and form for use in the RAG processing.

The RAG module 214 may call the LLM using the prompt and existing taxonomy, as in 706. Thus, the RAG module 214 may initiate an iteration of consolidating hyponyms to create candidate nodes.

The RAG module 214 may obtain votes for candidate nodes, as in 708. For example, the RAG module 214 may track or count the occurrences of candidate nodes output from an iteration of the RAG process.

The RAG module 214 may determine whether to perform another iteration with RAG before tallying results and selecting the new nodes, as in 710. In some embodiments, the RAG module may run a predetermined number of iterations, such as ten. In various embodiments, the number of iterations may be based on other factors such as the number of candidate hyponyms or based on other factors. When the RAG module 214 determines to perform another iteration and call the LLM again using a same prompt or different prompt (e.g., based on selected variation, etc.), following the “yes” route from the decision operation 710, then the process 700 may advance to the operation 706 to perform another iteration and obtain additional occurrences of hyponyms to tally with votes.

When the RAG module 214 determines not to perform another iteration and not call the LLM again using the same prompt or different prompt, following the “no” route from the decision operation 710, then the process 700 may advance to an operation 712. The RAG module may tally the occurrences (votes) for the candidate nodes that are generated for each iteration of the RAG performed by the LLM. For example, hyponyms may include a numeric value of the number of occurrences that a particular hyponym was included in results from RAG processing.

The RAG module 214 may apply thresholds to select the new nodes, as in 714. The threshold may be a minimum threshold which may reduce the occurrences of hallucinations from being selected as candidate new nodes. In some embodiments, only candidate nodes having enough votes may be included in a new node. In various embodiments, the top set of candidate nodes that have the most occurrences may be selected as the new nodes, such as the top five results.

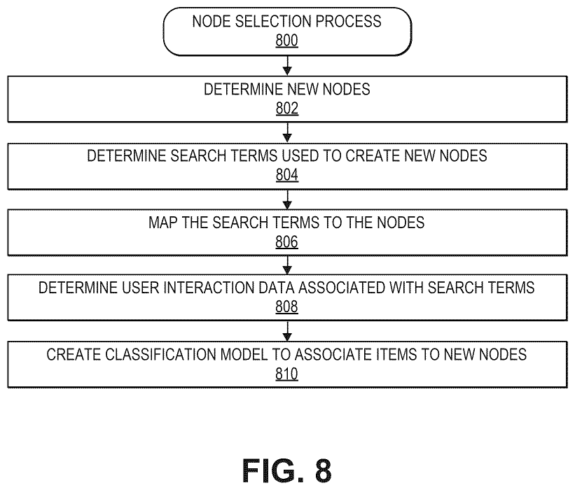

FIG. 8 is a flow diagram of an exemplary process 800 to create training data to associate content with new nodes of a taxonomy, according to exemplary implementations of the present disclosure. The process 800 may begin with the item classifier 216 determining the new nodes, as in 802. The new nodes may be identified by the process 700 described with reference to FIG. 7. The new nodes may be added to a taxonomy in relation to a seed concept (hypernode used to create the new nodes).

The item classifier 216 may determine search terms used to create the new nodes, as in 804. For example, search terms that are used to create the hypernym-hyponym pairings used for a seed concept may be identified by the item classifier 216. The item classifier 216 may determine the search terms from the search data 114.

The item classifier 216 may map the search terms to the new nodes, as in 806. By mapping the search terms to the new nodes, the item classifier 216 may use user interaction data associated with those search terms. The user interaction data may also be stored in the search data 114.

The item classifier 216 may determine the user interaction data associated with the search terms, as in 808. The user interaction data may include items accessed by a user in response to submission of the search terms and/or other user interaction information (e.g., refined search terms, etc.). The user interaction information may be used as training data for the item classifier 216 to map items or content to the new nodes.

The item classifier 216 may create a classification model to associate the items with the new nodes, as in 810. The classification model may use training data created by the operations 804-808. The item classifier 216 may use the classification model to select content to be presented to users in response to subsequent search queries using new nodes of the taxonomy. For example, the items shown in the third UI 316 of FIG. 3 may be associated with the new node of “ivy league” using the classification model.

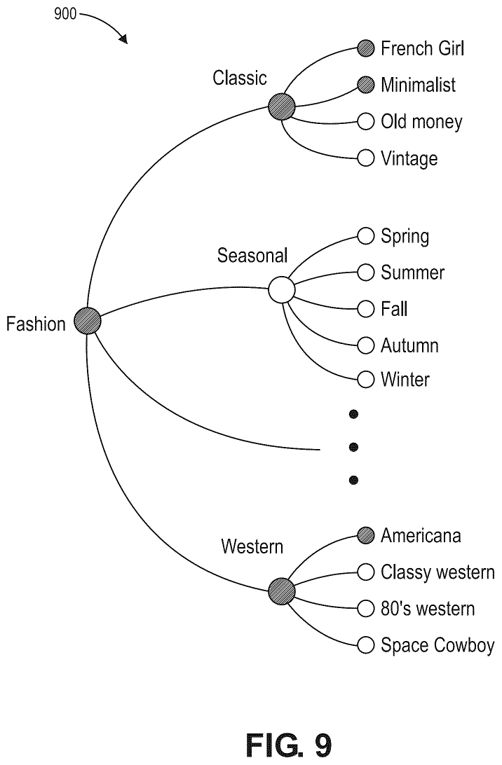

FIG. 9 is a schematic diagram of an illustrative taxonomy 900 that is automatically expanded to add new nodes based on user interaction with content, according to exemplary implementations of the present disclosure. The taxonomy 900 may be part of a large taxonomy. In this example, the taxonomy 900 relates to the term “fashion.” The taxonomy may include existing nodes represented by a filled circle and new nodes represented by an unfilled circle. The existing nodes may be part of an existing taxonomy that is used in a prompt for the RAG processing described with reference to FIG. 7. New nodes may be created by the process 400 and/or the process 700.

In the example taxonomy 900, the hypernym “Fashion” includes two existing results shown as “classic” and “western.” A new hyponym of “seasonal” may be created by the processes described above. Similarly, the term “classic” may be a hypernym of existing nodes of “French girl” and “minimalist” that are hyponyms. New hyponyms of “Old money” and “Vintage” may be created by the processes described above, but using a different seed concept of “Classic.” Meanwhile, since the node “seasonal” is new, the hyponyms under this hypernym may all be newly created nodes created by using the processes described above. Finally, the term “western” may be a hypernym of an existing node “americana” that is a hyponym. New hyponyms of “classy western,” “80's western,” and “space cowboy” may be created by the processes described above, but using a different seed concept of “western.”

This non-limiting example shows how new nodes can be automatically generated for inclusion in an existing taxonomy. New nodes may be created for a new taxonomy as long as seed concepts can be selected as discussed above. The taxonomy may be used to organize content to provide search results, a part of a UI interface to enable users to discover and retrieve content, and/or for other purposes. The processes described above may be run from time to time to update the taxonomy with new nodes as additional content becomes available over time. In this way, the taxonomy is updated automatically to reflect changes in content made available for user consumption.

While the taxonomy 900 only shows three layers, additional hyponyms may be added to create a fourth layer, a fifth layer, and so forth. In addition, the number of hyponyms for a given hypernym may not be limited to any specific quantity.

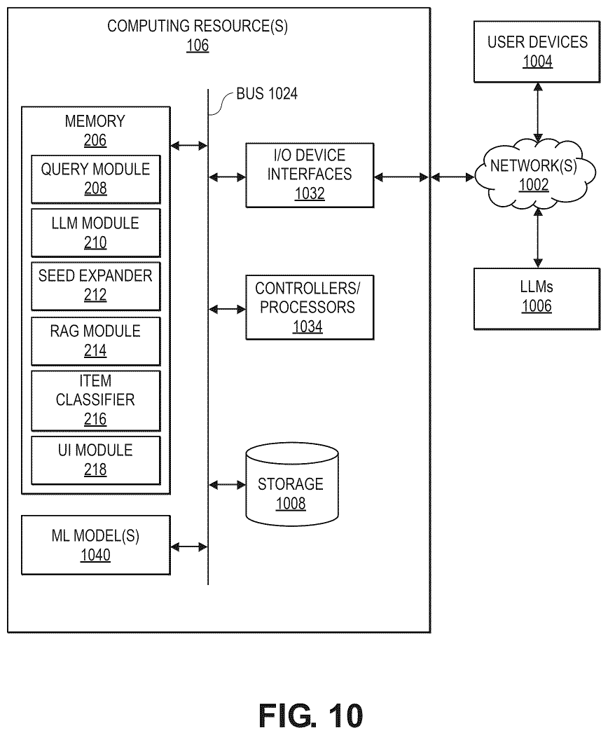

FIG. 10 is a block diagram illustrating the exemplary computing resources 106, according to exemplary implementations of the present disclosure. In exemplary implementations, multiple such computing resources 106 may be included in the system. Further, it is noted that computing resources 106 are a logical configuration and is not necessarily an actual configuration. Indeed, there may be numerous ways in which computing resources 106 may be implemented, and FIG. 10 should be viewed as illustrative and not limiting. In operation, each of these devices (or groups of devices) may include computer-readable and computer-executable instructions that reside on computing resources 106, as will be discussed further below.

Computing resources 106 may include one or more controllers/processors 1034, that may each include one or more central processing units (“CPU”) and/or graphics processing units (“GPU”) for processing data and computer-readable instructions, and memory 206 for storing data and instructions. Memory 206 may individually include volatile RAM, non-volatile ROM, non-volatile MRAM, and/or other types of memory. Computing resources 106 may also include a data storage component 1008 for storing data, user actions, content items, user information, user history, content information, other supplemental information, etc. Each data storage component may individually include one or more non-volatile storage types such as magnetic storage, optical storage, solid-state storage, etc. Computing resources 106 may also be connected to removable or external non-volatile memory and/or storage (such as a removable memory card, memory key drive, networked storage, etc.) through input/output device interfaces 1032. For example, the computing resources 106 may connect to and store/retrieve data from user devices 1004, LLMs 1006, and/or other sources via one or more network 1002.

Computer instructions for operating computing resources 106 and its various components may be executed by the controller(s)/processor(s) 1034, using memory 206 as temporary “working” storage at runtime. The computer instructions may be stored in a non-transitory manner in non-volatile memory 206, storage 1008, or an external device(s). Alternatively, some or all of the executable instructions may be embedded in hardware or firmware on computing resources 106 in addition to or instead of software.

For example, memory 206 may store program instructions that when executed by the controller(s)/processor(s) 1034 cause the controller(s)/processors 1034 to execute the various modules, components, and software described herein, including the query module 208, the LLM module 210, the seed expander 212, the RAG module 214, the item classifier 216, the UI module 218, etc.

Computing resources 106 also includes input/output device interface 1032 that connects the computing resources 106 with the one or more networks 1002, such as the Internet. A variety of components may be connected through input/output device interface 1032. Additionally, computing resources 106 may include address/data bus 1024 for conveying data among components of computing resources 106. Each component within computing resources 106 may also be directly connected to other components in addition to (or instead of) being connected to other components across the bus 1024.

The disclosed implementations discussed herein may be performed on one or more computing resources, such as computing resources 106 discussed with respect to FIG. 10 or performed on a combination of one or more computing resources. Further, the components of the computing resources 106, as illustrated in FIG. 10, are exemplary, and may be located as a stand-alone device or may be included, in whole or in part, as a component of a larger device or system.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Persons having ordinary skill in the field of computers, communications, image processing, and machine learning should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some, or all of the specific details and steps disclosed herein and/or that some steps or components discussed herein may be performed serially or in parallel.

Aspects of the disclosed system may be implemented as a computer method or as an article of manufacture such as a memory device or non-transitory computer-readable storage medium. The computer-readable storage medium may be readable by a computer and may comprise instructions for causing a computer or other device to perform processes described in the present disclosure. The computer-readable storage media may be implemented volatile computer memory, non-volatile computer memory, hard drive, solid-state memory, flash drive, removable disk, virtual drive, and/or other media.

The data and/or computer-executable instructions, programs, firmware, software and the like (also referred to herein as “computer-executable” components) described herein may be stored on a computer-readable medium that is within or accessible by computers or computer components such as computing resources 106, client device 104, or to any other computers or control systems, and having sequences of instructions which, when executed by one or more processors (e.g., CPU, GPU), cause the one or more processors to perform all or a portion of the functions, services and/or methods described herein. Such computer-executable instructions, programs, software and the like may be loaded into the memory of one or more computers using a drive mechanism associated with the computer readable medium, such as a floppy drive, CD-ROM drive, DVD-ROM drive, network interface, or the like, or via external connections.

Some implementations of the systems and methods of the present disclosure may also be provided as a computer-executable program product including a non-transitory machine-readable storage medium having stored thereon instructions (in compressed or uncompressed form) that may be used to program a computer (or other electronic device) to perform processes or methods described herein. The machine-readable storage media of the present disclosure may include, but is not limited to, hard drives, floppy diskettes, optical disks, CD-ROMs, DVDs, ROMs, RAMs, erasable programmable ROMs (“EPROM”), electrically erasable programmable ROMs (“EEPROM”), flash memory, magnetic or optical cards, solid-state memory devices, virtual drives, remote drives, or other types of media/machine-readable medium that may be suitable for storing electronic instructions. Further, implementations may also be provided as a computer-executable program product that includes a transitory machine-readable signal (in compressed or uncompressed form).

As used herein, the terms “product,” “item,” “object,” or like terms, may be used to refer to any good or service associated with a brand, and which may be depicted or referenced in one or more visual assets or audio content, or may be the subject of one or more advertisement creatives or other creative works. For example, products, items, or objects may include commercial goods, e.g., tangible objects that may be bought or sold, such as automobiles, books, clothing, computers, furniture, luggage, or others, as well as services, e.g., business services, social services, or personal services, such as travel, cruises, hair salons, personal training, legal or accounting services, or others.

It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Moreover, with respect to the one or more methods or processes of the present disclosure described herein, including but not limited to the flow chart shown in FIGS. 4 through 8, orders in which such methods or processes are presented are not intended to be construed as any limitation on the claimed inventions, and any number of the method or process steps or boxes described herein can be combined in any order and/or in parallel to implement the methods or processes described herein. Additionally, it should be appreciated that the detailed description is set forth with reference to the accompanying drawings, which are not drawn to scale.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The elements of a method, process, or algorithm described in connection with the implementations disclosed herein can be embodied directly in hardware, in a software module stored in one or more memory devices and executed by one or more processors, or in a combination of the two. A software module can reside in RAM, flash memory, ROM, EPROM, EEPROM, registers, a hard disk, a removable disk, a CD ROM, a DVD-ROM or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Disjunctive language such as the phrase “at least one of X, Y, or Z,” or “at least one of X, Y and Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the invention has been described and illustrated with respect to illustrative implementations thereof, the foregoing and various other additions and omissions may be made therein and thereto without departing from the spirit and scope of the present disclosure.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed is:

1. A computer-implemented method, comprising:
receiving a first user query of a desired item, the first user query including one or more terms;
storing the first user query with other user queries to create a collection of terms;
processing terms of the collection of terms using a large language model (LLM) to determine a hypernym for each of the terms;
creating a mapping with hypernym-hyponym pairings for each of the terms;
selecting a node from a taxonomy as a seed concept;
determining a first set including the seed concept and a plurality of hypernyms associated with the seed concept based at least in part on the hypernym-hyponym pairings;
creating a second set of hyponyms from the first set;
consolidating the hyponyms from the second set using retrieval augmented generation (RAG) to determine new nodes as children of the seed concept, the consolidating merging at least two similar hyponyms into a single hyponym;
adding the new nodes to the taxonomy as children of the seed concept;
associating items with the new nodes;
receiving a second user query of another desired item;
associating the user query with at least one of the new nodes of the seed concept; and
outputting items associated with the at least one of the new nodes in response to the second user query.

2. The computer-implemented method of claim 1, further comprising:
removing, from the second set, at least one hyponym that is also a hypernym in the first set.

3. The computer-implemented method of claim 1, further comprising:
determining, using the LLM, an additional hyponym that is absent from the collection of terms; and
associating the additional hyponym to one of the plurality of hypernyms.

4. The computer-implemented method of claim 1, further comprising
creating a prompt for the RAG, the prompt including at least:
the taxonomy;
the seed concept; and
the second set of hyponyms.

5. The computer-implemented method of claim 1, wherein the consolidating the hyponyms from the second set using the RAG include:
performing a plurality of iterations of the RAG, each iteration providing a set of results;
counting occurrences of each of the results of the plurality of iterations; and
selecting, as a new node, a subset of the results that each includes an occurrence greater than a threshold value.

6. The computer-implemented method of claim 1, further comprising:
selecting a second node from the taxonomy as a second seed concept;
determining a third set including the second seed concept and a second plurality of hypernyms associated with the second seed concept based at least in part on the hypernym-hyponym pairings;
creating a fourth set from additional hyponyms from the third set;
consolidating the additional hyponyms from the fourth set using retrieval augmented generation (RAG) to determine second new nodes as children of the second seed concept;
adding the second new nodes to the taxonomy as the children of the second seed concept; and
associating, with the second new nodes, second items being different than at least some of the items.

7. A computer-implemented method, comprising:
creating, using a Large Language Model (LLM), a mapping with hypernym-hyponym pairings for terms used in search queries;
processing a plurality of nodes of a taxonomy to create new nodes by:
selecting a node the plurality of nodes of the taxonomy as a seed concept;
determining a first set including the seed concept and a plurality of hypernyms associated with the seed concept based at least in part on the hypernym-hyponym pairings;
creating a second set of hyponyms from the first set;
consolidating the hyponyms from the second set using retrieval augmented generation (RAG) to determine at least some of the new nodes as children of the seed concept; and
adding the at least some of the new nodes to the taxonomy as children of the seed concept;
associating items with the new nodes of the taxonomy;
receiving, from a user device, a query associated with at least one of the new nodes; and
sending, to the user device and in response to the query, information for at least one of the items associated with the at least one of the new nodes.

8. A computer-implemented method of claim 7, further comprising:
performing the consolidating using the RAG for a predetermined number of iterations;
tracking the occurrences of hyponyms output from each iteration; and
selecting the new nodes based at least in part on the occurrences of the hyponyms.

9. A computer-implemented method of claim 7, further comprising:
generating a user interface to output the new nodes in the taxonomy, the new nodes being mapped to content organized by the taxonomy.

10. A computer-implemented method of claim 7, further comprising:
creating a prompt for the LLM or a second LLM to implement the RAG, the prompt including at least the seed concept, and the second set of hyponyms; and
providing the prompt to the LLM or the second LLM.

11. A computer-implemented method of claim 7, further comprising:
performing cosine similarity to select the plurality of hypernyms based on the seed concept.

12. A computer-implemented method of claim 7, wherein:
the query includes one or more terms that are associated with the at least one of the new nodes.

13. A computer-implemented method of claim 7, wherein the consolidating further includes at least one of:
clustering the hyponyms; or
random selection of a portion of the hyponyms for processing by an iteration of the RAG.

14. A computer-implemented method of claim 7, further comprising:
analyzing frequency of use of the terms, and
joining terms based at least in part on the frequency of use.

15. A computing system, comprising:
one or more processors; and
a memory storing program instructions that, when executed by the one or more processors, cause the one or more processors to at least:
receive a first user query of a desired item, the first user query including one or more terms;
create, using a Large Language Model (LLM), a mapping with hypernym-hyponym pairings for each of the terms;
select a node from a taxonomy as a seed concept;
determine a group of hypernyms associated with the seed concept based at least in part on the hypernym-hyponym pairings;
create a group of hyponyms from hyponyms in the group of hypernyms;
consolidate the hyponyms using retrieval augmented generation (RAG) to determine new nodes as children of the seed concept;
add the new nodes to the taxonomy as children of the seed concept;
associate items with the new nodes; and
send, to a user device and in response to a request, information for at least one of the items associated with the at least one of the new nodes.

16. The computing system of claim 15, wherein the program instructions that, when executed by the one or more processors, further cause the one or more processors to at least:
receive a second user query of another desired item;
associating the user query with at least one of the new nodes of the seed concept; and
outputting items mapped to the at least one of the new nodes in response to the second user query.

17. The computing system of claim 15, wherein the program instructions that, when executed by the one or more processors, further cause the one or more processors to at least:
process terms using the LLM to determine a hypernym for each of the terms.

18. The computing system of claim 15, wherein the program instructions that, when executed by the one or more processors, further cause the one or more processors to at least:
determine, for at least some hypernyms and using the LLM, additional hyponyms that are absent from the terms.

19. The computing system of claim 15, wherein the program instructions that, when executed by the one or more processors, further cause the one or more processors to at least:
remove, from the group of hyponyms, at least one hyponym that is also a hypernym in the group of hypernyms.

20. The computing system of claim 15, wherein the program instructions that, when executed by the one or more processors, further cause the one or more processors to at least:
select a second node from the taxonomy as a second seed concept;
determine a second a group of hyponyms from the second group of hypernyms;
consolidate the second group of hyponyms using RAG to determine second new nodes as children of the second seed concept; and
add the second new nodes to the taxonomy as the children of the second seed concept.
